(19) United States
(12) Patent Application Publication
(10) Pub. No.: US 2005/0011922 A1
(43) Pub. Date: Jan. 20, 2005

(54) Retaining net to be mounted on surfaces in the cockpit and/or trunk of motor vehicles

(76) Inventor: Hans-Erich Nolle, Schwelm (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/496,776

(22) PCT Filed: Nov. 6, 2002
(86) PCT No.: PCT/EP02/12352

(30) Foreign Application Priority Data
Dec. 12, 2001 (DE) 201 20 090.2

(51) Int. Cl. B60R 5/00; B60R 11/06; B62D 25/24; B60R 7/00; B60R 9/00; B62D 43/00; B60R 11/00

(52) U.S. Cl. 224/563; 296/37.1; 224/557

(57) ABSTRACT

Disclosed is a retaining net to be mounted on surfaces in the passenger compartment and/or trunk of motor vehicles. The inventive retaining net is provided with a net Fart, two plastic rails (3) which are disposed at opposite ends of the net part, and two elastic ties that are disposed at the other two opposite ends of the net part and are mounted on the two plastic rails (3). In order to facilitate the manufacturing and mounting of said retaining net, the two plastic rails (3) are provided with one recess (10) for each end mesh at the end of the net part assigned thereto. The net strings embodying the external angle of the end mesh arc inserted into the recesses (10) which are placed at an equal distance next to or underneath each other in the plastic rails (3). A wire is disposed on the inside (16) of each plastic rail (3), opposite the net part (2). Said wire stretches along the recesses (10) disposed in the plastic rail (3) and extends through the external angles of the end meshes of the net part.

The present invention relates to a retaining net to be mounted on surfaces in the passenger compartment and/or trunk of a motor vehicle; this retaining net comprises a net part, two plastic rails that are disposed at opposite ends of the net part, and two elastic tension elements that are disposed at the other two opposite ends of the net part and are each mounted on the two plastic rails.

During recent decades, retaining nets of this kind have become ever more desirable items of standard equipment for motor vehicles. They are used at many different locations within the passenger compartments and/or trunks of motor vehicles to hold the most varied objects.

It is the objective of the present invention to so develop a retaining net of the aforesaid type, which is to be attached to surfaces within the passenger compartment and/or trunk of a motor vehicle, that it can be manufactured and installed for a very small technical and structural outlay.

According to the present invention, this task has been solved in that the two plastic rails of the retaining net incorporate a recess for each edge mesh on the edge of the retaining net that is associated with it, and into which the net strings that form the outer corner of the edge mesh can be introduced; in that the recesses in the plastic rails are disposed at equal distances adjacent to or beneath each other; and in that a wire is disposed on the inner side of each plastic rail that is remote from the net part; this wire extends along the recesses in the plastic rail and passes through the outer corners of the edge meshes of the net part. This provides an easily formed possibility for fixing the edges of the net part in the plastic rails which, in their turn, can be attached to any installation surface within the passenger compartment and/or trunk of the motor vehicle for a very small outlay. However, less costly and simple attachment of the net part to the plastic rails, which holds the net part of the retaining net in an exact position, is made possible by the combined function of the wire and the appropriately shaped plastic rail.

In order to fix the wire in relation to the plastic rail, it is helpful if retaining clips be arranged on the inner side of the plastic rails, by means of which the wire that fixes the outer corners of the edge meshes on the inner side of the plastic rail can itself be fixed in position. The retaining clips are best disposed between the recesses that accommodate the outer corners of the edge meshes.

It is advantageous that each plastic rail be formed in one piece and be of a U-cross section, the recesses that are formed in the plastic rail being positioned at the approximate mid-point in the bottom of the U-cross section of the plastic rail. The superficial extent of the net part can thus be oriented so as to be both parallel to the bottom of the plastic rail as well as perpendicular to the bottom of the plastic rail.

In order to join the two elastic tension elements, by which the two other opposite edges of the net part are formed, to the plastic rail for a relatively small technical and structural outlay, it is appropriate that the two plastic rails incorporate above the uppermost recess and below the lowermost recess an opening through which the end of the tension element that is associated with the corresponding end of the plastic rail protrudes into the interior space of the plastic rail that is formed by the U-cross section, each end of each of the tension elements being provided with a retaining head, the diameter of which is greater than that of the opening, so that the ends of the elastic tension elements are fixed within the plastic rails in a durable and reliable manner.

The wire can be reliably prevented from slipping out of, in particular, the outer corner of the uppermost or lowest edge mesh of the net part if the arrangement of the two openings in a plastic rail and the length of the wire associated with the plastic rail are so selected that the wire can be fixed longitudinally by the retaining heads in the area of the plastic rail that has the openings.

It is, of course, possible that at least one of the two plastic rails is a component part of a plastic profile part of, for example, a seat profile, backrest profile, bulkhead profile, door profile, or the like. Both plastic rails can also be realized in one of the aforementioned profiles.

In order to be able to arrange a closed net at any height, it is useful if one edge of the retaining net that is formed by one of the elastic tension elements be configured so as to be attachable to an installation surface.

The present invention is described in greater detail below on the basis of an embodiment shown in the drawings appended hereto. These drawings show the following:

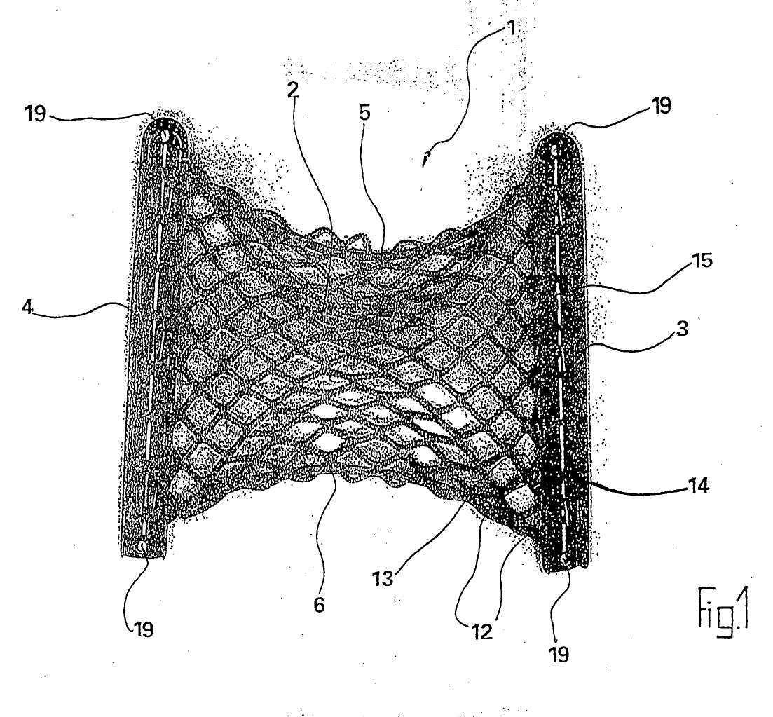

FIG. 1: A rear view of one embodiment of a retaining net according to the present invention;

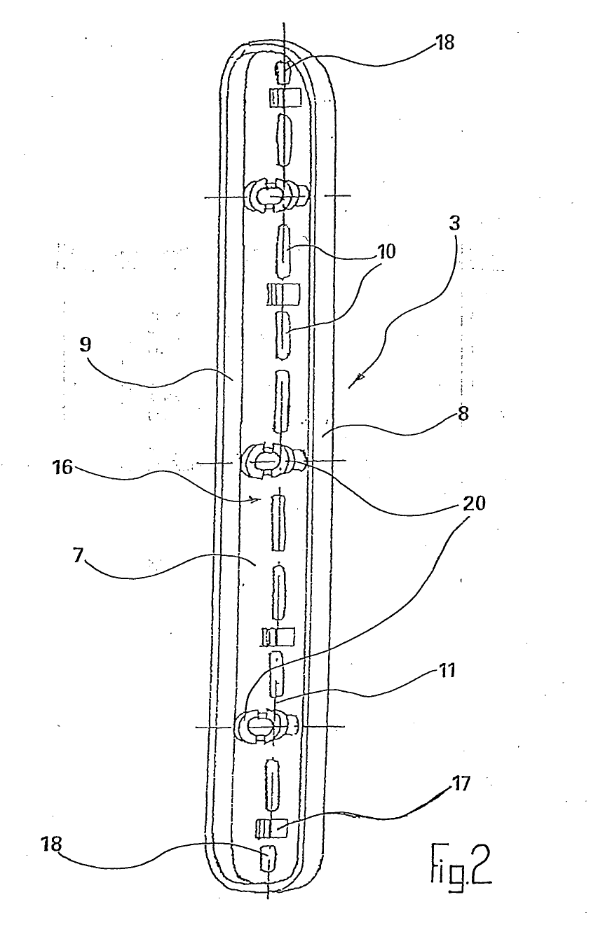

FIG. 2: A rear view of a plastic rail of the retaining net according to the present invention as shown in FIG. 1.

The retaining net 1 according to the present invention, which is shown in FIG. 1 and FIG. 2 and described in greater detail below, is intended for installation in the interiors or trunks of motor vehicles, where it serves to hold or anchor objects of any kind.

In the embodiment as shown, the retaining net 1 has a net part 2, which is four-sided, a plastic rail 3, 4 being disposed on the two opposite edges of the net part 2, which extend vertically in FIG. 1.

The two plastic rails 3, 4 correspond to each other with respect to function and configuration, so that in the following, to the extent that details of the plastic rails 3, 4 are discussed, reference is made only to the plastic rail 3, a rear view of which is shown in FIG. 2.

An elastic tension element 5, 6 stretches between the two upper ends of the plastic rails 3, 4 respectively, and these form the upper or lower edge of the net part 2 of the retaining net 1. The ends of the two elastic tension elements 5, 6 are attached in a manner that is described below to the ends of the plastic rails 3, 4 that are associated with them.

As can be seen from FIG. 2, the two plastic rails 3, 4 are each of U-shaped cross section consisting of a base 7 and two sides 8, 9.

There are slot-like recesses 10 in the base 7 of the plastic rail 3. These slot-like recesses are aligned with each other along a vertical middle line 11 of the base 7 of the plastic rail 3.

Two net strings 13, 14 that form an outside corner of an edge mesh 12 of the net part 2 pass through each of these recesses 10 into the interior space formed in the plastic rail 3 by the base 7 and the sides 8, 9.

A wire 15, shown in FIG. 1, passes through the outside corners of the edge mesh 12 of the net part 2 that are formed by the net strings 13, 14 and protrude into the interior space of the plastic rail 3; this wire 15 extends across the whole area of the vertical middle line 11 of the plastic rail 3, along which the recesses 10 that accommodate the net strings 13, 14 are arranged.

Snap-type retaining clips 17 are provided in order to fix the wire 15 to the inner side of the base 7 of the plastic rail, and these are formed between two recesses 10 on the inner side 16 of the plastic rails 3, on the vertical middle line 11 of its base 7.

Openings 18 are formed in the end sections of the plastic rails 3, 4, above the uppermost recess 10 or beneath the lowest recess 10, so as to fix the ends of the two elastic tension elements 5, 6. The ends of the elastic tension elements 5, 6 protrude through these openings 18 into the interior space that is formed by the base 7 and the sides 8, 9 of the plastic rail 3. The ends of the elastic tension elements 5, 6 are secured by retaining heads 19 that form the ends of the elastic tension elements 5, 6 and are of a greater diameter than that of the openings 18.

In the embodiment shown, the openings 18 and, as a result of this, the retaining heads 19 are arranged immediately beneath or above the retaining clips 17 that serve to hold the wire 15, on the vertical middle line 11 of the base 7 of the plastic rail 3. This prevents the wire 15 slipping out of place in the vertical direction to the point that it no longer reaches through the outer corner of an edge mesh 12 of the net part 2.

The plastic rails 3, 4 have clip connectors 20, by means of which they can be attached to the intended installation surface.

In certain locations in which the retaining net 1 is used, it can be useful if the lower elastic tension element 6 is so configured that it can be attached to the installation surface in a suitable manner so that a retaining net 1 that is closed at the bottom will result.

1. Retaining net for installation on surfaces within the interiors and/or the trunks of motor vehicles, with a net part (2), two edge retainers (3, 4) that are disposed on opposite edges of the net part (2) and which incorporate a recess (10) for each edge mesh (12) on the edge of the net part (2) that is associated with them, into which recesses (10) the two net strings (13, 14) that form the outer corner of the edge mesh (12) can be inserted and which are disposed so as to be spaced apart at equal distances adjacent to or beneath one another; and with an elastic tension element (5) that is disposed on a first other edge of the net part (2) and attached to both edge retainers (3, 4); and with a wire (15) that is disposed on the inner side (16) of each edge retainer (3, 4) that is remote from the net part (2), which extends along the recesses (10) that are formed in the edge retainer (3, 4) and passes through the outer corners of the edge meshes (12) of the net part (2), characterized in that the two edge retainers are one-piece plastic rails (3, 4) that are of approximate U-cross section; and in that a second elastic tension element (6) is attached on the second, other edge of the net part and secured to the plastic rails (3, 4).

2. Retaining net as defined in claim 1, in which retaining clips (17) are formed on the inner side (16) of the plastic rail (3, 4), by means of which the wire (15) that fixes the outer corners of the edge meshes (12) on to the inner side (16) of the plastic rails (3, 4) can itself be fixed in position.

3. Retaining net as defined in claim 1, in which each plastic rail (3, 4) is formed in one piece and is of approximate U-cross section, the recesses (10) that are formed in the plastic rail (3, 4) being disposed approximately at the middle of the base (7) of the U-cross section of the plastic rail (3, 4).

4. Retaining net as defined in claim 1, in which in each of the two plastic rails (3, 4), above the uppermost and below the lowest recess (10), there is in each instance an opening (18) through which the end of the particular tension element (5, 6) that is associated with the corresponding end section of the plastic rail (3, 4) protrudes into the interior space of the plastic rail (3, 4) that is formed by the U-cross section, each end of each tension element (5, 6) being fitted in the interior space of the plastic rail (3, 4) with a retaining head (19), the diameter of which is greater than the opening (18).

5. Retaining net as defined in claim 4, in which the arrangement of the two openings (18) in a plastic rail (3, 4) and the length of the wire associated with the plastic rail (3, 4) are such that the wire (15) can be fixed longitudinally by the retaining heads (19) associated with the two openings (18) in the area of the plastic rail (3, 4) that incorporates the recesses (10).

6. Retaining net as defined claim 1, in which at least one of the plastic rails (3, 4) is a component part of a plastic profile component of a motor vehicle, e.g., a seat profile, seat-back profile, bulkhead profile, door profile, or the like.

7. Retaining net as defined in claim 1, in which an edge of the retaining net (1) that is formed by one of the elastic tension elements (5, 6) is configured so as to be attachable to an installation surface.
